(19) United States
(12) Patent Application Publication
(10) Pub. No.: US 2006/0238146 A1
(43) Pub. Date: Oct. 26, 2006

(54) METHODS AND APPARATUS TO ENHANCE OPERATION OF FLUORESCENT LAMPS

(76) Inventor: Mihail S. Moisin, Brookline, MA (US)

Correspondence Address: Paul D. Durkee;DALY, CROWLEY, MOFFORD & DURKEE, LLP, Suite 301A, 354A Turnpike Street, Canton, MA, 02021-2714, US

(21) Appl. No.: 11/379,718

(22) Filed: Apr. 21, 2006

Related U.S. Application Data
(60) Provisional application No. 60/674,425, filed on Apr. 25, 2005.

(51) Int. Cl. H05B 37/02

(52) U.S. Cl. 315/309

(57) ABSTRACT

A shield around a cathode of a fluorescent lamp, inside the lamp, prevents the overheating of the glass wall of the lamp, in the proximity of the cathode and the premature of the cathode due to the parasitic leakage current to ground.

### CROSS REFERENCE TO RELATED APPLICATIONS

The present application claims the benefit of the Provisional U.S. Patent Application No. 60/674,425 filed on Apr. 25, 2005, which is incorporated herein by reference.

### STATEMENT REGARDING FEDERALLY SPONSORED RESEARCH

Not Applicable.

### FIELD OF THE INVENTION

The present invention relates generally to florescent lamps and, more particularly, to compact fluorescent lamps (CFL).

### BACKGROUND OF THE INVENTION

As is known in the art, there are disadvantages associated with the operation of conventional Fluorescent Lamps and especially Compact Fluorescent Lamps (CFL). One such problem is known as “End of Life Cathode Overheating”. CFL lamps though, because of the small diameter of the glass, have a tendency to overheat around the cathode area, when the Lamp approaches the End of Life.

Prior art attempts to address this problem include the use of complicated electronic circuitry, which is designed to recognize the Lamp operating near the End of Life and limit or totally shut down the power transferred to the Lamp. One draw back of this type of circuitry is the fact that it may kick-in when the Lamp is not really at the End of Life, thus interfering with the normal operation of the Lamp. End of Life Overheating can be a serious issue since it can lead to melting down of the glass and eventually creating a Safety or Fire Hazard.

One reason for this melting down of the glass occurs is due to a Hot Spot on the Cathode, in the near proximity of the Glass.

Another disadvantage associated with the operation of conventional Fluorescent Lamps and especially Compact Fluorescent Lamps (CFL) is related to the High Frequency Leakage to Ground. For example, when a Lamp is being used for dimming applications in particular, or for any other application in general, as the Lamp Current goes down in order to dim the Lamp, a high Voltage develops across the Lamp, especially for small diameter CFL's. This high voltage is more noticeable on Amalgam based CFL vs. Mercury based CFL, because of the physics of the gas. The Voltage across the lamp can reach values in the range of 1.6 kVpp or higher.

This very high voltage may easily translate into a high voltage between any Cathode and Ground, which in turn translates into a leakage current between the Cathode and Ground, via the leakage parasitic capacitance naturally developed between them.

This leakage current increases in amplitude as the frequency increases, leading to the so called “sputtering” effect of the Cathode, where the emissive material coating the cathode is being depleted very rapidly, leading in turn to the premature aging of the lamp and the very early “end of life” phenomenon.

It would, therefore, be desirable to overcome the aforesaid and other disadvantages.

### SUMMARY OF THE INVENTION

The present invention provides a way of mitigating the effects of overheating of the Cathode Filaments in a Fluorescent Lamp and in particular in a Compact Fluorescent Lamp. It also provides a way of increasing the life expectancy of the Lamp, especially operating in dim conditions, at a reduced power level, by minimizing the parasitic leakage current from the Cathode Filament to Ground.

In one aspect of the invention, a shield placed around the cathode plays the role of thermo buffering the amount of heat generated by the cathode, from reaching the glass of the lamp proximate to the cathode. One area of the shield is connected to the cathode, thus allowing the shield to operate as a heat-sink. An electrically conductive shield will further play the role of minimizing the parasitic capacitance developed between the cathode and Ground, thus reducing the equivalent parasitic leakage current to Ground.

In another aspect of the invention, the shield is split in two halves, each half being connected to one of the two ends of the cathode. This arrangement will allow for a more uniform transfer of heat and for a more balanced split of the parasitic capacitance developed between the cathode and Ground.

The invention will be more fully understood from the following detailed description taken in conjunction with the accompanying drawings, in which:

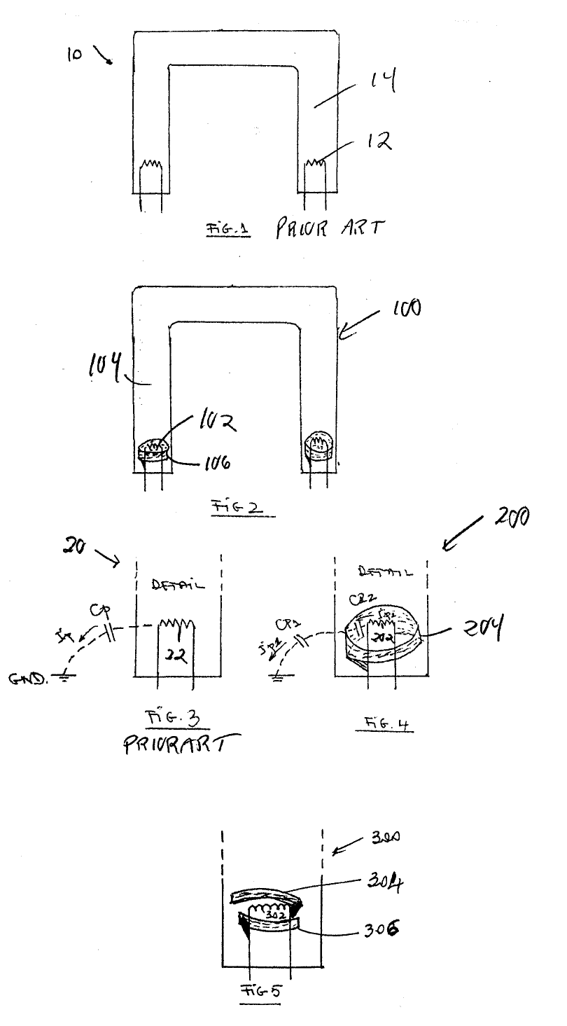

FIG. 1 shows a typical prior art arrangement 10 having a cathode filament 12 inside a Lamp 14. It will be readily apparent that, as the Lamp 14 diameter goes down, the glass in the proximity of the Cathode 12 is prone to overheat around a Hot Spot.

FIG. 2 shows a lamp 100 having cathode 102 inside a lamp 104 with a shield 106 proximate the cathode in accordance with one exemplary embodiment of the invention. In illustrative embodiments, a metal circular mesh or solid ring is placed around the cathode, being electrically connected to one end of the Cathode.

The shield 106 acts as a shield by distributing heat generated by a Hot Spot on the Cathode 102, thus preventing the glass from overheating and eventually melting down.

FIG. 3 shows a prior art lamp 20 having a cathode 22 with a parasitic Capacitance Cp developed between a Cathode and Ground. This Capacitance Cp generates a leakage path for a leakage transversal Current Ip, from the Cathode to Ground (GND.) A conventional CFL is not designed for this transversal leakage current from the Cathode to Ground. This parasitic current shortens the life expectancy of the lamp as it creates an accelerated depletion of the emissive coating material of the Cathode.

FIG. 4 shows a portion of a lamp 200 having a Cathode 202 surrounded by a shield 204 in accordance with one embodiment of the invention. The shield 204, which can be a Metal Mesh or Ring around the Cathode, effectively splits the parasitic capacitor Cp into two capacitors Cp1 and Cp2, connected in series. A parasitic current Ip1 develops between the shield 204 and Ground.

FIG. 5 shows a portion of a lamp 300 having a Cathode 302 surrounded by a shield made out of two halves 304 and 306 in accordance to one embodiment of the invention. The two halves 304 and 306 of the shield can be Metal Meshes or Half-Rings around the Cathode.

FIG. 4 shows a portion of a lamp 200 having a Cathode 202 surrounded by a shield 204 in accordance with the invention.

A parasitic current Ip1 naturally develops between the shield 204 and Ground.

Since the shield 204 is connected to one end of the Cathode 202, another small parasitic current Ip2 develops between the Cathode 202 and the shield 204. Since the voltage differential between any point on the Cathode and the shield is in the range of few Volts, the parasitic current Ip2 may be about 1,000 times (three orders of magnitude) smaller than the original Ip parasitic current, not large enough to generate sputtering of the Cathode, thus preserving the life of the lamp.

It is understood that the geometry and the material for the shield can vary greatly to meet the needs of a particular application. A variety of shapes and materials suitable for the shield will be apparent to one of ordinary skill in the art. In general, the shield should distribute heat generated by the cathode and be sufficiently conductive for the parasitic current. In one embodiment, the shield can be provided as a metal mesh generally ring-shaped or cylindrical about the cathode. The shield need not be continuous about the cathode.

If only the thermo shielding effect is sought, the shield could be made out of a non-electrically conductive, like a high temperature rated ceramic material.

What is claimed is:

1. A shield placed around a cathode of a fluorescent lamp, inside the lamp, for preventing the overheating of the glass wall of the lamp, in the proximity of the cathode.

2. The shield of claim 1 placed partially around the cathode.

3. The shield of claim 1 made out of a thermo resistant ceramic material.

4. The shield of claim 1 made out of thermo resistant plastic material.

5. The shield of claim 1 made out of a thermo resistant material.

6. An electrically conductive shield placed around a cathode of a fluorescent lamp, electrically connected to the cathode, for preventing the electrical coupling of the cathode to the external media.

7. The shield of claim 6, where the external media is the ground.

8. The shield of claim 6 placed partially around the cathode.

9. A method of preventing the cathode degradation by placing an electrically conductive shield in the proximity of a cathode of a fluorescent lamp, inside the lamp and electrically connected to the cathode.

10. The method of claim 9 with the shield placed around the cathode.

11. The method of claim 9 with the shield placed partially around the cathode.

12. The method of claim 9, further including minimizing cathode leakage current to ground.
